(19) United States
(12) Patent Application Publication
(10) Pub. No.: US 2005/0105136 A1
(43) Pub. Date: May 19, 2005

(54) Print density setting method for image-forming apparatuses

(75) Inventor: Son-Hae Jung, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/985,881

(22) Filed: Nov. 12, 2004

(30) Foreign Application Priority Data
Nov. 13, 2003 (KR) 2003-80013

(51) Int. Cl. G06K 15/00; H04N 1/46

(52) U.S. Cl. 358/3.1; 358/3.01

(57) ABSTRACT

A print density setting method for image-forming apparatuses is disclosed. The print density setting method for an image-forming apparatus capable of forming an image based on at least three or more color data and black data comprises steps of, when the image is formed in monotone, setting a combination ratio of data for a composite black created based on a mixing of the three colors, to the data for the black color; and setting print density of the image to be formed based on the black data in the set combination ratio. Such a print density setting method can vary the density of an image created according to user's taste, and, when a user wants to minimize the ink consumption amount, the user sets the consumption amounts of the color ink and the black inks.

### CROSS-REFERENCE TO RELATED APPLICATIONS

This application claims the benefit under 35 U.S.C. §119(a) of Korean Patent Application No. 2003-80013, filed on Nov. 13, 2003, the entire contents of which is incorporated herein by reference.

### BACKGROUND OF THE INVENTION

1. Field of the Invention

The present invention relates to a print density setting method for image-forming apparatuses, such as color printers.

2. Description of the Related Art

Inkjet printers, bubble jet printers, and color laser printers use four ink colors, which are typically cyan, magenta, yellow, and black (CMYK) ink colors. The inkjet or bubble jet printers reproduce full color images with the CMYK inks, and the laser printers reproduce color images with the CMYK toners. Unlike an image signal reproducing a white color when the red, green, and blue (RGB) colors are mixed, the image-forming apparatuses using the four CMYK inks or toners reproduce the color black when the three CMY colors are mixed.

Therefore, the image-forming apparatuses capable of color printing can create the color black by using the three CMY colors, and the created black color is generally referred to as the composite black color. Such a composite black color has the feature of appearing “natural” compared to images created by black inks or toners, when black and white images are reproduced with color inks or toners.

FIGS. 1A to 1C are views for explaining a method for creating a composite black color in image-forming apparatuses.

First, FIG. 1A is a view for creating a mono black color on a sheet of paper. As shown in FIG. 1A, the mono black color is created when the black ink (K) (or toner) of the CMYK inks (or toners) is printed on a sheet of paper. The mono black enables the clearest print quality to be obtained since the black ink (K) is directly printed on a sheet of paper.

Next, FIG. 1B is a view for showing the composite black color created with the three CMY colors. The composite black color based on the three CMY colors is created by mixing the C, M, and Y colors. The overlapped portion of the three colors (CMY) creates the color black, or a color near the color black, and the non-overlapped portions have the original colors. Thus, when the color black is expressed by using the composite black created with the three CMY colors, the effect is blurry looking as compared to the mono black color. The use of such an effect enables images such as water-color paintings or pictures to be expressed smoothly, but is not appropriate for character expressions since the characters look blurred when expressed.

Lastly, FIG. 1C is a view for showing the composite black color created by use of the CMYK colors. FIG. 1C is a view for showing a method for reducing the consumption of the CMY inks (or toners) by additionally firing the K ink (or toner) to create the composite black. In general, the color inks or toners are more expensive than the black inks or toners, so the use of such a method can reduce the consumption of the CMY inks or toners. Hereinafter, the composite black color refers to a color created with the CMYK colors mixed as described in FIG. 1C.

FIG. 2A and FIG. 2B are views for showing a method creating the composite black based on the Under Color Replacement (UCR) method.

First, FIG. 2A is a view showing the amounts of ink consumed, color by color, to create composite black.

More specifically, FIG. 2A shows one example where CMYK inks of 60 μl, 50 μl, 80 μl, 70 μl respectively, form one composite black color. Here, the consumption amounts of the respective color inks are only exemplary numerical values with the unit of μl, ml, or the like, which are given for the purpose of easy explanation and understanding. However, one will understand that this should not be construed as limiting.

In one particular example, 50 μl of black color is created with the 50 μl of each of CMY inks, which is equivalent to the same density as that of the black color created by the 50 μl of black ink (K). Theoretically, the black color created from the CMY inks provides almost the same effect as the black ink (K) by itself. However, much more CMY inks are consumed as compared to the black ink (K) in order to generate a composite black color of equal density. More specifically, the density of the black color using only black ink (K) is almost the same as that of the black color created by the respective CMY inks. Furthermore, the density of the consumed amount of 50 μl of the black ink composed from the CMY inks is nearly the same as the density of the consumed amount of 100 μl of the black ink (K). Accordingly, with reference to FIG. 2A, 10 μl of cyan ink, one of magenta ink and 10 μl of yellow ink are required to create the composite black color.

FIG. 2B is a view showing the Under Color Replacement (UCR) method for reducing the consumption amounts of the CMY inks from the ink consumption amounts shown in FIG. 2A.

As shown in FIG. 2B, the UCR method is to use the black ink (K) amounting to 20 μl of the consumption of the CMY inks, to thereby reduce the consumption of the respective CMY inks by the corresponding amount of 20 μl each. That is, the consumption of the CMYK inks shown in FIG. 2A amounts to 260 μl (6 μl +50 μl +80 μl +70 μl), but that of the CMYK inks shown in FIG. 2B amounts to 220 μl (40 μl +30 μl +60 μl +90 μl), so upon the creation of the composite black, the application of the UCR method can reduce the total amount of ink consumed.

However, the UCR method fixes constant the ratio of changing the CMY ink volumes into the black ink volume, so users can not change the ratio arbitrarily, which is because the makers of the image-forming apparatuses apply the UCR method to the extent of keeping image quality appropriate, but which causes a problem since the UCR method can not cope with the user's needs in respect of every type of usage. For example, performing test printing causes users to waste unnecessary ink upon printing based on the ratio set by the maker, and the images formed based on the UCR method set by the maker may not satisfy the user's taste. Thus, embodiments of the present invention describe a print density setting method for image-forming apparatuses capable of enabling image quality to be set by individual users as well as reducing the consumption amount of ink much more.

### SUMMARY OF THE INVENTION

The present invention has been developed in order to solve the above drawbacks and other problems associated with the conventional arrangement. An aspect of the present invention is to provide a print density setting method for image-forming apparatuses capable of enabling users to set the composition of the composite black color by use of color inks and black inks as well as reducing the consumption amount of the inks.

The foregoing and other objects and advantages are substantially realized by providing a print density setting method for an image-forming apparatus capable of forming an image based on data with respect to at least three or more colors and data with respect to a black color, comprising the steps of when the image is formed in monotone, setting a combination ratio of data for a composite black created based on a mixing of the at least three or more colors, to the data for the color black; and setting the print density of the image to be formed based on the black color data in the set combination ratio.

Preferably, the step of setting the combination ratio includes the steps of displaying on a predetermined display device options for setting the combination ratio of the composite black data to the black data; and setting print density based on the respective color data and black data to create the composite black through the options selected.

Preferably, the step of setting the print density based on the black data includes the steps of setting reference values with respect to the respective color data; and decreasing the print density based on the respective color data according to the set reference values, and compensating for the print density based on the black data by the decreased print density.

Preferably, the step of setting the print density of the image to be formed based on the black data increases or decreases the print density with respect to the compensated black data.

Preferably, the options include a first option for setting the print density reference values with respect to the respective color data; and a second option for increasing or decreasing the print density based on the black data.

Preferably, the steps of setting the combination ratio and setting the image print density are implemented in a form of a driver program on an information processing device applying print data to the image-forming apparatus.

Preferably, the combination ratio is provided in the image-forming apparatus in advance.

Preferably, the image-forming apparatus is any of an inkjet printer, a bubble jet printer, a laser printer, a digital photocopier, and a combination machine constructed with selected ones of the above three devices.

### BRIEF DESCRIPTION OF THE DRAWINGS

The above aspects and features of the present invention will be more apparent by describing certain embodiments of the present invention with reference to the accompanying drawings, in which:

FIGS. 1A, 1B, and 1C are views for explaining a method for creating a composite black by an image-forming apparatus;

FIG. 2A and FIG. 2B are views showing the creation of a composite black according to the Under Color Replacement (UCR) method;

FIGS. 3A, 3B, and 3C are views for conceptually explaining a print density setting method according to an embodiment of the present invention;

FIG. 4 is a view showing a driver program to which the UCR method is applied according to an embodiment of the present invention; and

FIG. 5 is a flowchart showing a print density setting method for image-forming apparatuses according to a preferred embodiment of the present invention.

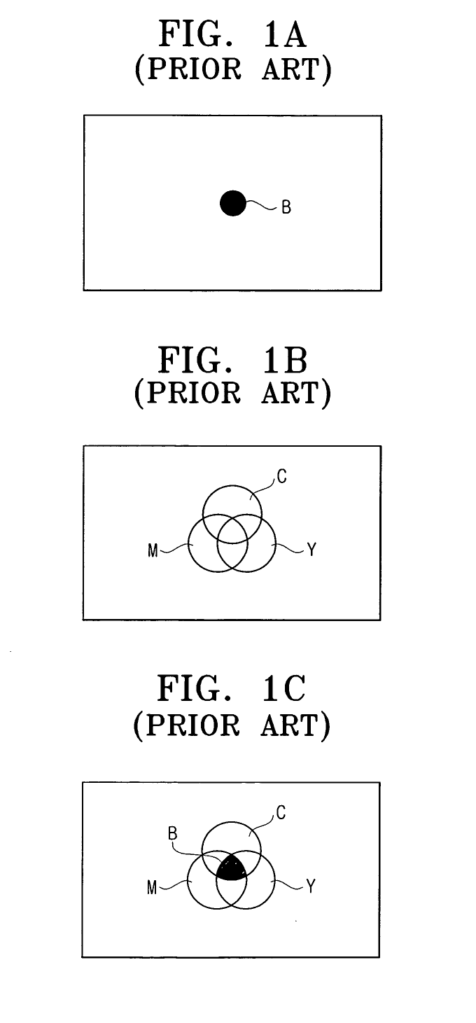

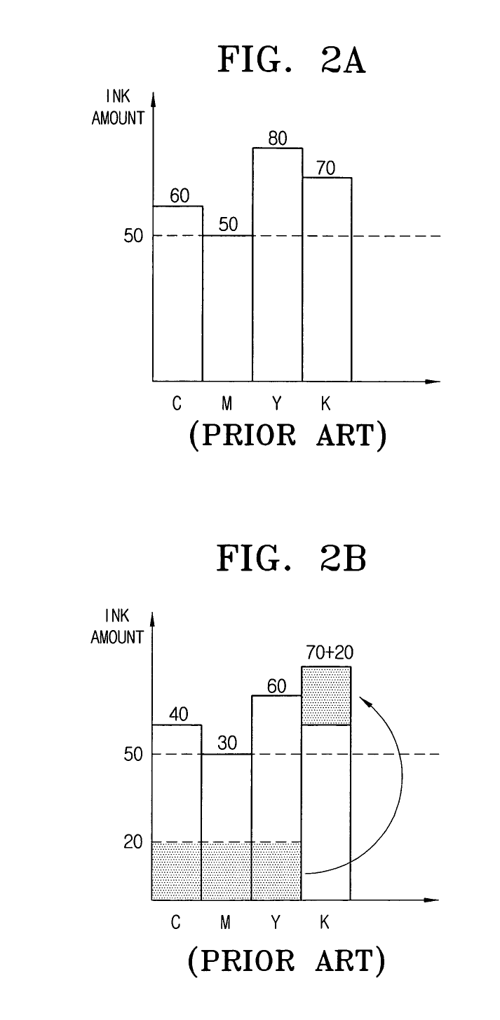

### DETAILED DESCRIPTION OF THE EXEMPLARY EMBODIMENTS

Hereinafter, the present invention will be described in detail with reference to the accompanying drawings.

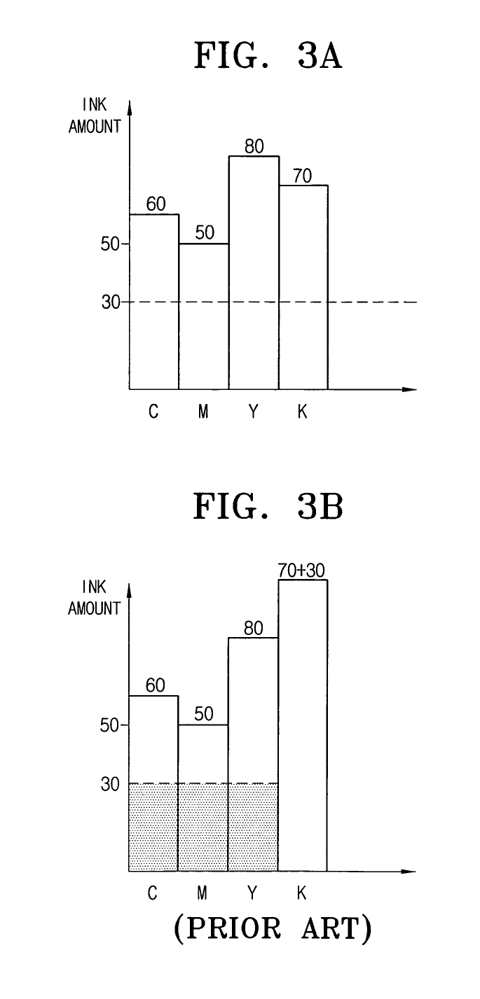

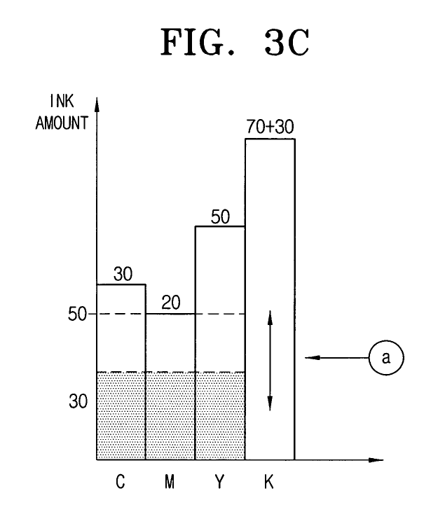

FIGS. 3A to 3C are views for conceptually explaining a print density setting method according to an embodiment of the present invention.

First, FIG. 3A shows exemplary consumption amounts of color inks for creating a composite black.

As shown in FIG. 3A, the CMYK color inks are fired to consume as much as, for example, 60 μl, 50 μl, 80 μl, and 70 μl, respectively, of ink to create one composite black. The consumption amounts of the individual color inks are numerical values given for the convenience of explanation and understanding, and the unit therefor can be varied to μl, ml, or the like, but not limited thereto. In the present embodiment, the unit for the ink consumption amounts will be μl for the purpose of easy understanding, but one will understand that this should not be construed as limiting.

As shown in FIG. 3A, the CMY inks use as much as 50 μl of each color ink, respectively, to create the portion color is expressed as black, the density of which is the same as that formed with the 50 μl of the black ink (K) alone. Thus, the consumption amount of the CMY inks is 150 μl, but the density substantially corresponds to that formed with the 50 μl of the black ink (K) alone.

Therefore, the density formed with the consumption amounts of 50 μl, for example, of the respective CMY inks is the same as that formed with the consumption amount of 50 μl, for example, of the black ink (K). Using 50 μl of black ink (K) has the same visual effect as using 10 μl, 0 μl, and 30 μl of CMY inks, respectively, which excludes the 50 μl of cyan ink, the 50 μl of magenta ink and the 50 μl of yellow ink typically used to create the color black.

FIG. 3B shows a compensation amount for the black inks with respect to the color inks as they would be reduced when the conventional Under Color Replacement method is applied.

FIG. 3C shows an Under Color Replacement method for increasing or decreasing the final ink consumption amount by increasing or decreasing the black ink compensated for in FIG. 3B according to an embodiment of the present invention. A reference symbol “a” denotes a gauge bar for increasing or decreasing the amount of the black ink (K) by users, by which the users can decrease the consumption amount of the black ink (K) to decrease the final consumption amount of the CMYK inks. For example, when the gauge bar is adjusted for the consumption amount of the black ink (K) to be set to 50 μl, the whole ink consumption amounts to 200 μl (30 μl +20 μl +50 μl +50 μl), so the ink consumption amount can be further decreased as compared to the conventional Under Color Replacement method. On the contrary, for example, when a user wants images to be dark, much more ink can be consumed as compared to the conventional UCR method, but, if the user wishes to decrease the consumption amount of ink, the Under Color Removal method according to the present invention is very useful to the user. In here, when the Under Color Removal method is to be applied, the conventional Under Color Replacement (UCR) method can be used together therewith, or the Under Color Removal can be used alone. The description has been made with respect to the color inks and the black ink with reference to FIGS. 3A to 3C, for example, for the convenience of explanation, but, the same description can be applied to laser printers using color toners and the black and white toner, even though it is not described in this embodiment to avoid the same repetitive description. However, one will understand that the concept of the present invention should not be construed as limited to the inkjet or bubble jet printers only. Further, the description has been made on the CMYK inks throughout the present disclosure, but the present invention can be applied to a variety of image-forming apparatuses using five or six inks color rather than the CMYK inks. For example, image-forming apparatuses or photo printers using six inks such as cyan, magenta, yellow, light cyan, light magenta, and black, can also be applied, because the Under Color Removal or the Under Color Replacement (UCR) can be applied to the additional colors, not only the CMYK colors.

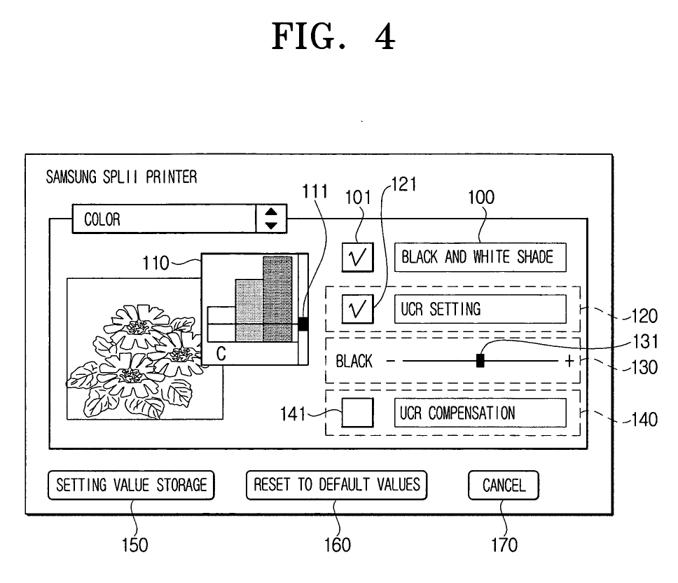

FIG. 4 is a view showing a driver program to which the Under Color Removal method is applied according to an embodiment of the present invention.

In general, image-forming apparatuses such as inkjet printer, laser printer, and digital photocopier are connected to a personal computer (not shown), and a driver program is installed in the personal computer to drive a corresponding image-forming apparatus. The installed driver program with a user interface program therefor enables a user to set the print quality and the print options in detail. FIG. 4 shows an exemplary user interface program for setting the driver program in detail. A reference number 101 denotes an option for setting a black and white/color print mode. Reference number 110 denotes an option for setting a ratio of the composite black by sliding gauge bar 111. Reference number 120 denotes an option for selecting by actuating button 121 whether or not an option of the Under Color Removal is applied according to an embodiment of the present invention. Reference numeral 130 denotes an option for increasing or decreasing the black ink, which is performed by sliding gauge bar 131 right and left, respectively, upon the application of the Under Color Removal according to an embodiment of the present invention. Reference number 140 denotes an option for selecting whether or not the conventional Under Color Replacement method according to an embodiment of the present invention is applied together with Under Color Removal. A reference number 150 denotes an option for storing in the driver program setting values selected by a user, while reference number 160 denotes an option for loading default setting values into the driver program. Reference number 170 denotes an option for canceling a value set by the user.

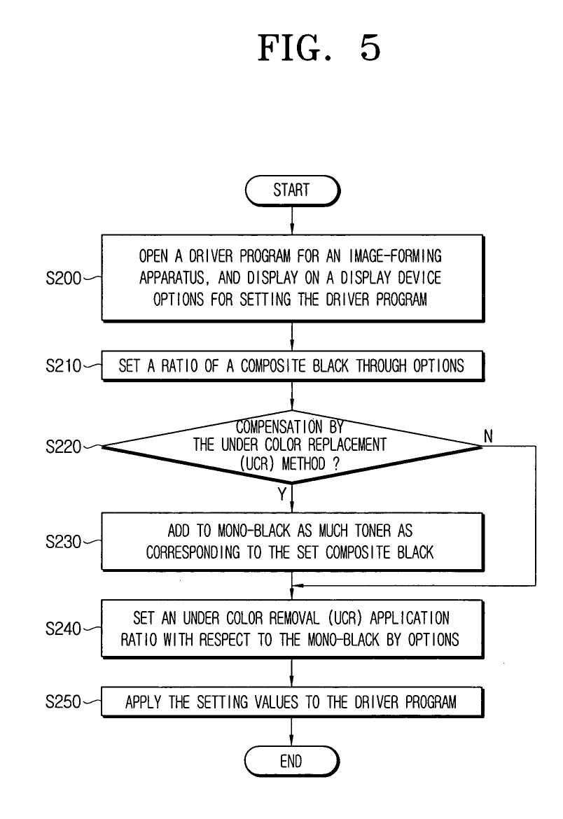

FIG. 5 is a flowchart showing a print density setting method for image-forming apparatuses according to a preferred embodiment of the present invention.

First, a user selects a driver program for the image-forming apparatus and displays the user interface window on the screen for setting (S200). The user interface options displayed on the screen can be found in FIG. 4. Next, if the user processes in mono-tone and prints a color image, the user presses a check box 101 for selection that is provided on the left side of the black and white option 100. If the check box is selected, the option 110 for setting a mixture ratio for a composite black is displayed on one side of the window. The user moves up and down the gauge bar 111 by use of an input device such as a mouse (not shown) or a keyboard (not shown) to set the ratio of the black created with the CMY colors (S210). Next, the user selects whether the Under Color Replacement method is applied (S220) according to the ratio of the composite black that has been set in step S210. When the Under Color Replacement method is selected to be applied, the consumption amount of the black ink (K) is increased to as much as the composite black color created with the CMY inks (S230). If the Under Color Replacement method is not selected to be applied, step S240 is carried out. In step S240, the Under Color Removal method is applied to the mono-black ink as set in the options at S210, to thereby increase or decrease the consumption amount of the black ink. The user moves the gauge bar 131 provided on the option 130 to set the amount of the black ink to be increased or decreased. As the gauge bar 131 of the option 130 moves to the right, the density of an image to be printed by the image-forming apparatus becomes darker, and, as the gauge bar 131 moves in the opposite direction, the density of the image becomes lighter. Lastly, if the user selects the setting value storage option 150, a setting value selected by the user is applied to the driver program (S250).

As above, the user himself can set the print quality for an object that he wishes to print, as well as reduce the ink consumption amount by adjusting the consumption amounts of the color ink and the black ink through the gauge bars 111 and 131. As described above, embodiments of the present invention can vary the density of an image created according to a user's taste, and, when a user wants to minimize the ink consumption amount, the embodiments of the present invention enable the user to set the consumption amounts of the color ink and the black inks as much as the user wants. The description has been primarily made with respect to color inks, but can be applied to the color toners in the same manner. Even in case of color toners, the consumption amount of the toners can be minimized while obtaining the image quality that the users wish.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A print density setting method for an image-forming apparatus capable of forming an image based on data with respect to at least three colors and data with respect to a black color, the method comprising the steps of:
when the image is formed in monotone, setting a combination ratio of data for a composite black created based on mixing at least three colors, to the black color data; and
setting a print density of the image to be formed based on the black color data in the set combination ratio.

2. The print density setting method as claimed in claim 1, wherein the step of setting the combination ratio includes the steps of:
displaying on a predetermined display device a menu for setting the combination ratio of a composite black color data to the black color data; and
setting print density based on the respective color data and black color data to create the composite black color through menu options.

3. The print density setting method as claimed in claim 2, wherein the step of setting the print density based on the black data comprises the steps of:
setting reference values with respect to the respective color data; and
decreasing the print density based on the respective color data according to the set reference values, and compensating for the print density based on the black color data by the decreased print density.

4. The print density setting method as claimed in claim 3, wherein the step of setting the print density of the image to be formed based on the black color data increases or decreases the print density with respect to the compensated black color data.

5. The print density setting method as claimed in claim 2, wherein the menu options include:
a first option for setting the print density reference values with respect to the respective color data; and
a second option for increasing or decreasing the print density based on the black color data.

6. The print density setting method as claimed in claim 1, wherein the steps of setting the combination ratio and setting the image print density are implemented in a form of a driver program on an information processing device applying print data to the image-forming apparatus.

7. The print density setting method as claimed in claim 1, wherein the combination ratio is provided in the image-forming apparatus in advance.

8. The print density setting method as claimed in claim 1, wherein the image-forming apparatus is any of an inkjet printer, a bubble jet printer, a laser printer, a digital photocopier, and a combination machine constructed with selected ones of the above three devices.
